(19) United States
(12) Patent Application Publication
(10) Pub. No.: US 2015/0363512 A1
(43) Pub. Date: Dec. 17, 2015

(54) SYSTEM AND METHOD FOR OPTIMIZING CONNECTOR DESIGN

(71) Applicant: Cheng Uei Precision Industry Co., Ltd., New Taipei City (TW)

(72) Inventors: SHENG YUAN HUANG, New Taipei City (TW); YI CHING HSU, New Taipei City (TW); KUO CHIN LIN, New Taipei City (TW); HAN WEI WANG, New Taipei City (TW)

(21) Appl. No.: 14/302,388

(22) Filed: Jun. 11, 2014

(51) Int. Cl. G06F 17/50; G06F 17/18

(52) U.S. Cl. CPC G06F 17/50; G06F 17/18

(57) ABSTRACT

A system for optimizing connector design includes at least one digital model, an operating interface, an orthogonal table generating module, a model generating module, a definite element analysis module, a taguchi calculating module and a report module. A method for optimizing connector design is described hereinafter. Choose the digital model, and choose a target analysis element, a quality characteristics, tolerances of terminal thickness, tolerances of butting dimensions, orthogonal table format, and key dimensions and tolerances of the digital model. Generate multiple test parameters, and generate multiple groups of test models according to the digital model, the tolerances of terminal thickness, the tolerances of butting dimensions and the test parameters. Proceed a definite element analysis to get the parameters of the insertion and withdrawal forces according to the test models. Proceed a taguchi calculation to get relation variances, and make an analysis report according to the relation variances.

### BACKGROUND OF THE INVENTION

1. Field of the Invention

The present invention generally relates to a system for optimizing connector design, and more particularly to a system for optimizing connector design which applies taguchi method, and a method for optimizing connector design.

2. The Related Art

In product design, dimensions and tolerances are always factors which affect process costs of the product, and also affect an output of the product, especially in connector design, the dimensions and tolerances of some parts of the connector also directly affect insertion and withdrawal forces, usage life, and stability of signals, so it must make the optimum dimension and tolerance of each part of the connector more rigorously.

Take an audio jack connector for example, terminals assembled in the audio jack connector have different shapes and dimensions that makes conditions of affecting the insertion and withdrawal forces become wider, in general, the optimum dimension and tolerance are got by virtue of senior designers' experience and a large number of tests, so it need spend a lot of time and costs.

In the process of getting the optimum dimension and tolerance, full factorial design method, one-factor-at-a-time method, fractional factorial design method, taguchi method and other methods can be applied. The taguchi method utilizes a simple orthogonal table cooperating with taguchi formulae to calculate a dimension variance so as to determine the dimension and tolerance, so, the taguchi method is helpful to take less test times to get the optimum dimension and tolerance.

The taguchi method can sharply decrease test groups by virtue of the orthogonal table and the taguchi formulae, but it still needs a certain number of test conditions to proceed a physical test, it still spends a lot of time and costs.

So, in order to save the time-consuming physical test from the test conditions, it can adopt a perennially popular finite element analysis method in recent years, and thereby proceed the definite element analysis on the generated digital model through an algorithm in a computer.

After getting the definite element analysis data, apply the taguchi method to get relation variances, real reference targets are provided to developers through variance analysis of the taguchi method to greatly decrease development time.

However, in the process of operating the taguchi method and the finite element analysis, it still needs to spend a certain schedule, and the process of operating the taguchi method and the finite element analysis is complicated. As a result, people are apt to make mistakes in the process of processing the orthogonal table and the digital model filing. In view of this, a system for optimizing connector design which applies the taguchi method, and a method for optimizing connector design are provided by the present invention, the system for optimizing connector design automatically outputs the analysis report after the user inputs the analysis conditions by virtue of the method for optimizing connector design to make the analysis data accurate. Thereby, a basis of optimizing the key dimensions and tolerances of the connector are got to reach a purpose of shortening the development time and lowering the costs.

### SUMMARY OF THE INVENTION

An object of the present invention is to provide a system and a method for optimizing connector design. The system for optimizing connector design includes at least one digital model, an operating interface for selecting the digital model and inputting analysis conditions which include target analysis elements, quality characteristics, tolerances of terminal thickness, tolerances of butting dimensions, orthogonal table format, and key dimensions and tolerances of the digital model, an orthogonal table generating module for reading and calculating the key dimensions and tolerances, and the orthogonal table format to generate multiple groups of test parameters, a model generating module for reading and calculating test parameters of the orthogonal table generating module and the tolerances of terminal thickness of the operating interface, the tolerances of butting dimensions and the digital model of the database to generate multiple groups of test models, a definite element analysis module for proceeding a definite element analysis to get the parameters of insertion and withdrawal forces of the multiple groups of test models, a taguchi calculating module for calculating the quality characteristics and the parameters of the insertion and withdrawal forces to get relation variances, and a report module for calculating the relation variances generated by the taguchi calculating module to make an analysis report.

The method for optimizing connector design is described hereinafter. Choose the digital model, and choose the target analysis element, the quality characteristics, the tolerances of terminal thickness, the tolerances of butting dimensions, the orthogonal table format, and the key dimensions and tolerances of the digital model. Generate multiple test parameters according to the orthogonal table format and the key dimensions and tolerances, and generate the multiple groups of test models according to the digital model, the tolerances of terminal thickness, the tolerances of butting dimensions and the test parameters. Proceed the definite element analysis to get the parameters of the insertion and withdrawal forces according to the test models. Proceed a taguchi calculation to get the relation variances according to the quality characteristics, the parameters of insertion and withdrawal forces, and make the analysis report according to the relation variances.

As described above, the system for optimizing connector design automatically outputs the analysis report after the user inputs the analysis conditions by virtue of the method for optimizing connector design to make the analysis data accurate. Thereby, a basis of optimizing the key dimensions and tolerances of the connector are got to reach a purpose of shortening the development time and lowering the costs.

### BRIEF DESCRIPTION OF THE DRAWINGS

The present invention will be apparent to those skilled in the art by reading the following description, with reference to the attached drawings, in which:

FIG. 1 is a schematic diagram of a system for optimizing connector design in accordance with the present invention;

FIG. 2 is a schematic block diagram of the system for optimizing connector design of FIG. 1;

FIG. 3 is a schematic diagram of an operation interface of the system for optimizing connector design of FIG. 1;

FIG. 4 shows a table which lists contribution data of insertion forces of terminals of an audio connector in accordance with the present invention;

FIG. 5 shows a table which lists contribution data of withdrawal forces of the terminals of the audio connector in accordance with the present invention;

FIG. 6 shows a table which lists test parameters of key dimensions and tolerances expanded in L₁₂ (2¹¹) orthogonal table format in accordance with the present invention;

FIG. 7 shows another table which lists test parameters of the key dimensions and tolerances expanded in L₁₂ (2¹¹) orthogonal table format in accordance with the present invention;

FIG. 8 shows a table which lists parameters of the insertion forces after a test model in accordance with the present invention through a definite element analysis module to be calculated;

FIG. 9 shows a table which lists parameters of the withdrawal forces after the test model in accordance with the present invention through the definite element analysis module to be calculated;

FIG. 10 shows an analysis report of the insertion forces after the parameters of the insertion forces are calculated through a taguchi calculation module;

FIG. 11 shows an analysis report of the withdrawal forces after the parameters of the withdrawal forces are calculated through the taguchi calculation module;

FIG. 12 shows a table which lists the optimizing dimensions and the tolerances optimized by a digital model directing at the analysis report;

FIG. 13 shows a table which lists variances of the overall insertion and withdrawal forces before and after modifications of the dimensions and tolerances;

FIG. 14 is another schematic diagram of the system for optimizing connector design in accordance with the present invention; and

FIG. 15 is a flow chart of a method for optimizing connector design in accordance with the present invention.

### DETAILED DESCRIPTION OF THE PREFERRED EMBODIMENT

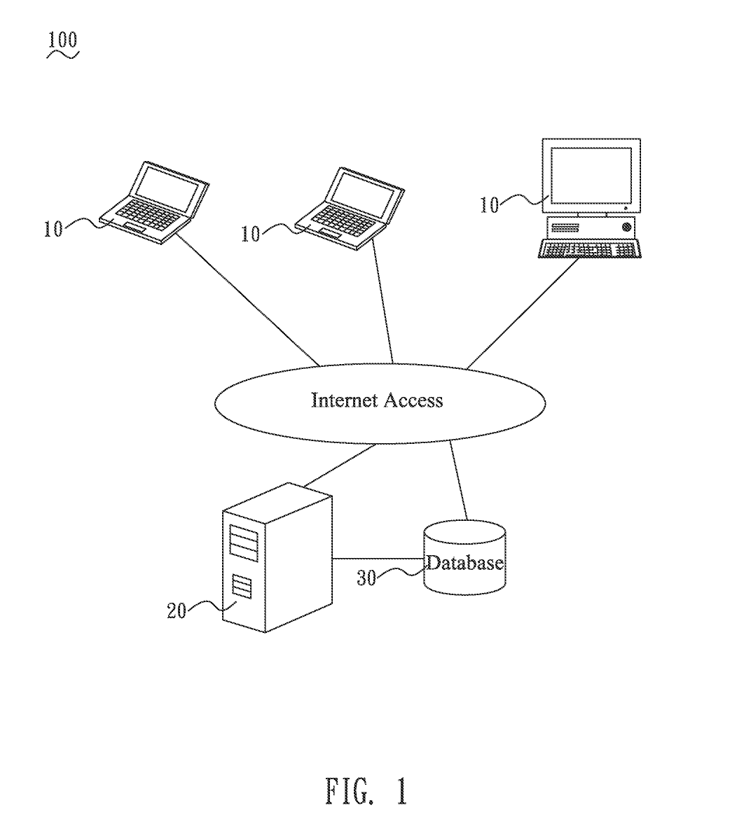

With reference to FIG. 1 to FIG. 3, a system for optimizing connector design 100 which applies taguchi method, and a method for optimizing connector design in accordance with the present invention are shown. The system for optimizing connector design 100 and the method for optimizing connector design are adapted for making an optimum analysis report of dimensions and tolerances of a connector. The system for optimizing connector design 100 includes a plurality of computers 10, a calculation server 20 and a database 30. The computers 10 interface with the calculation server 20 and the database 30, and are acted as clients for calling the calculation server 20 and the database 30. The calculation server 20 interfaces with the database 30 and is acted as a data processing terminal for proceeding data calculation. The database 30 is used for storing data. The computers 10 interface with the calculation server 20 and the database 30 by virtue of an internet access, a point-to-point transmission or a connecting cable. The calculation server 20 interfaces with the database 30 by virtue of the internet access, the point-to-point transmission or the connecting cable.

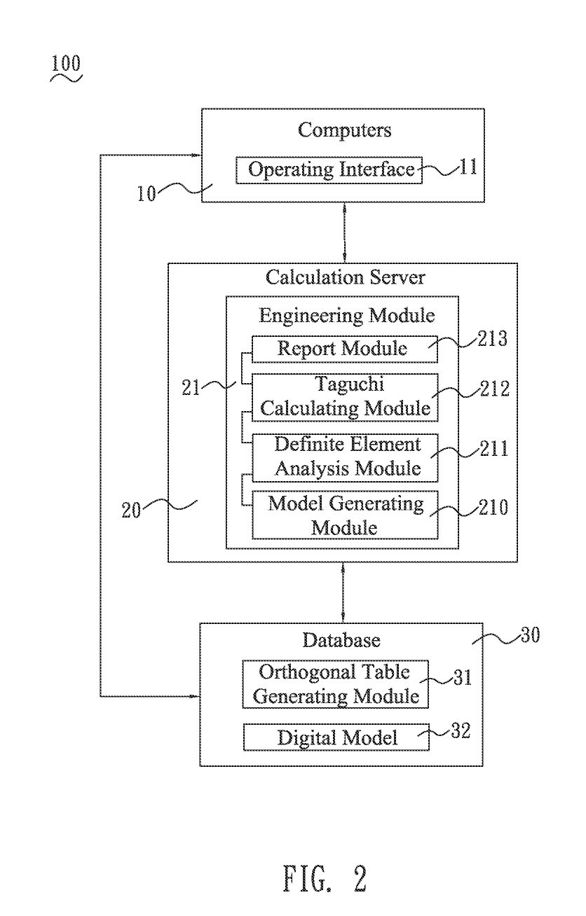

Referring to FIG. 2, the calculation server 20 is equipped with an engineering module 21. The engineering module 21 for proceeding analysis report calculation, includes a model generating module 210 for reading and calculating test parameters of the orthogonal table generating module 31 and the tolerances of terminal thickness of the operating interface 11, the tolerances of butting dimensions and the digital model 32 of the database 30 to generate multiple groups of test models, a definite element analysis module 211 for proceeding a definite element analysis to get the parameters of insertion and withdrawal forces of the multiple groups of test models, a taguchi calculating module 212 for calculating the quality characteristics and the parameters of the insertion and withdrawal forces to get relation variances, and a report module 213 for calculating the relation variances generated by the taguchi calculating module 212 to make the analysis report.

Referring to FIG. 2, the database 30 stores an orthogonal table generating module 31 and at least one digital model 32. The orthogonal table generating module 31 is for reading and calculating the key dimensions and tolerances, and the orthogonal table format to generate multiple groups of test parameters. The digital model 32 is capable of being stored in the database 30 in advance, or input into the database 30 through the operating interface 11.

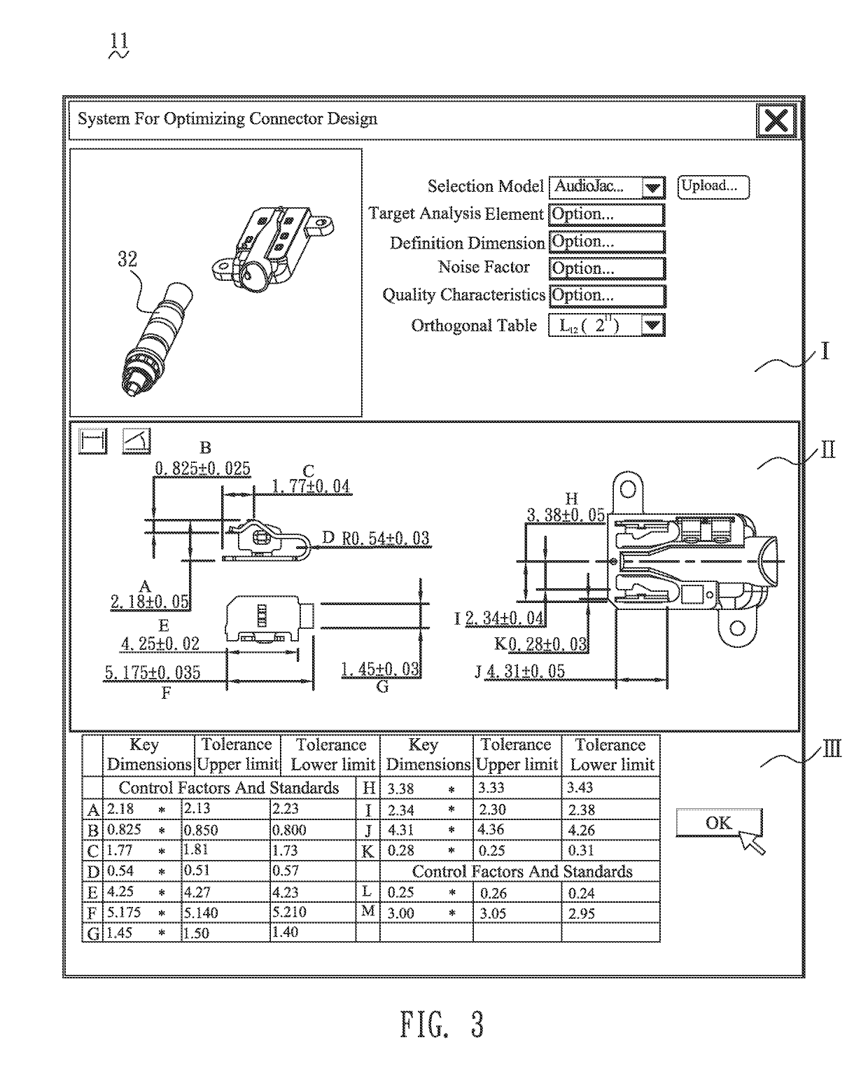

Referring to FIG. 2 and FIG. 3, the digital model 32 is a three-dimensional model of the connector, and is drawn by virtue of an application program of computer auxiliary design, such as SolidWorks, ProE, AutoCad or drawn by other application programs which can develop the three-dimensional model. The digital model 32 includes dimension information of each part of the connector and a definite element analysis parameterization.

Referring to FIG. 2 and FIG. 3, the definite element analysis parameterization is used for making the definite element analysis module 211 acted as analysis conditions of definite elements. The definite element analysis parameterization includes a material property, a network characteristic, a boundary condition and a constraint condition of the digital model 32.

Referring to FIG. 1 to FIG. 3, the computer 10 is equipped with an operating interface 11 for selecting the digital model 32 and inputting the analysis conditions. The operating interface 11 can call the engineering module 21 of the calculation server 20, and input the digital model 32 which needs to be analyzed into the database 30. A user can input the analysis conditions into the operating interface 11 and call the calculation server 20 and the database 30 through the operating interface 11 for executing the engineering module 21 and the orthogonal table generating module 31.

Referring to FIG. 2 and FIG. 3, specifically, the analysis conditions include target analysis elements, quality characteristics, tolerances of terminal thickness, tolerances of butting dimensions, orthogonal table format, and key dimensions and tolerances of the digital model 32.

The tolerances of butting dimensions are respectively designated as an upper limit and a lower limit of a diameter of a butting connector.

The tolerances of terminal thickness and the tolerances of butting dimensions are noise factors defined in taguchi method, the key dimensions and tolerances are control factors and standards defined in the taguchi method.

Different quality characteristics are corresponding to different taguchi analysis formulae. The quality characteristics include nominal-the-best characteristic, smaller-the-better characteristic, and larger-the-better characteristic. When the nominal-the-best characteristic is chosen, it needs to direct at the nominal-the-best characteristic to choose a target force value.

Referring to FIG. 1 to FIG. 3, the user can input the analysis conditions into the calculation server 20 and the database 30 through the operating interface 11 and call the calculation server 20 and the database 30 so as to execute the corresponding actions. After each engineering module 21 completes executing the calculation, call the next engineering module 21 through the operating interface 11 so as to execute the calculation.

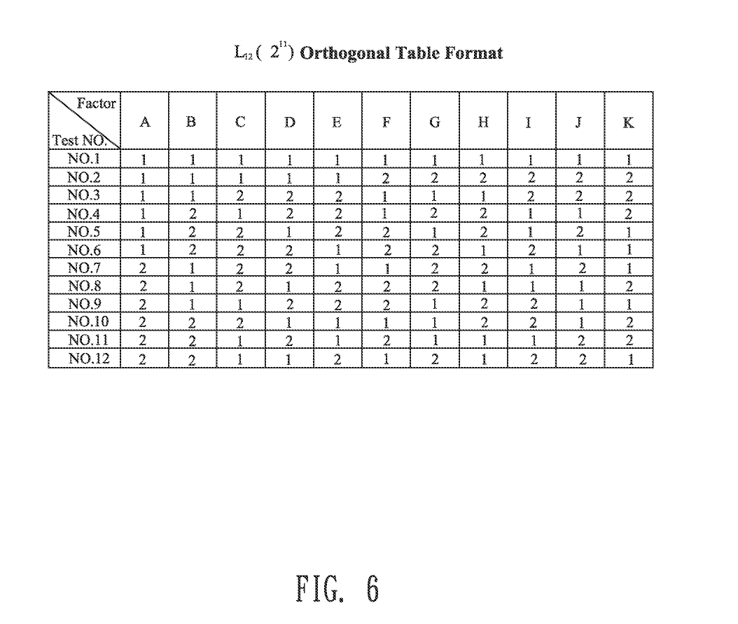

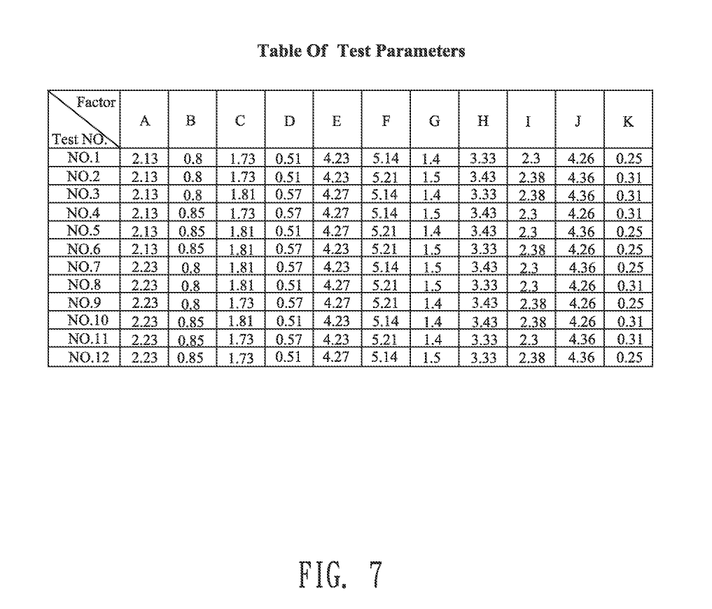

Referring to FIG. 1, FIG. 2, FIG. 3, FIG. 6 and FIG. 7, here lists a calling method among the operating interface 11, the engineering module 21, the orthogonal table generating module 31 and the digital models 32, and according to a first embodiment of the present invention. After the orthogonal table generating module 31 receives the call of the operating interface 11, read and calculate the key dimensions and tolerances, and the orthogonal table format to generate the multiple groups of test parameters.

After the model generating module 210 receives the call of the operating interface 11, reads and calculates test parameters of the orthogonal table generating module 31 and the tolerances of terminal thickness of the operating interface 11, the tolerances of butting dimensions and the digital model 32 of the database 30 to generate the multiple groups of test models.

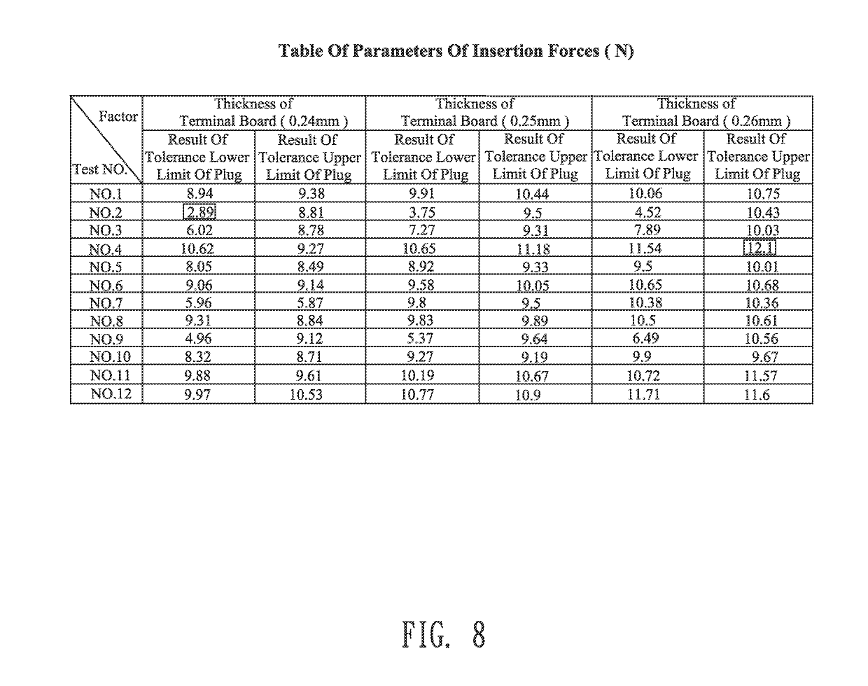

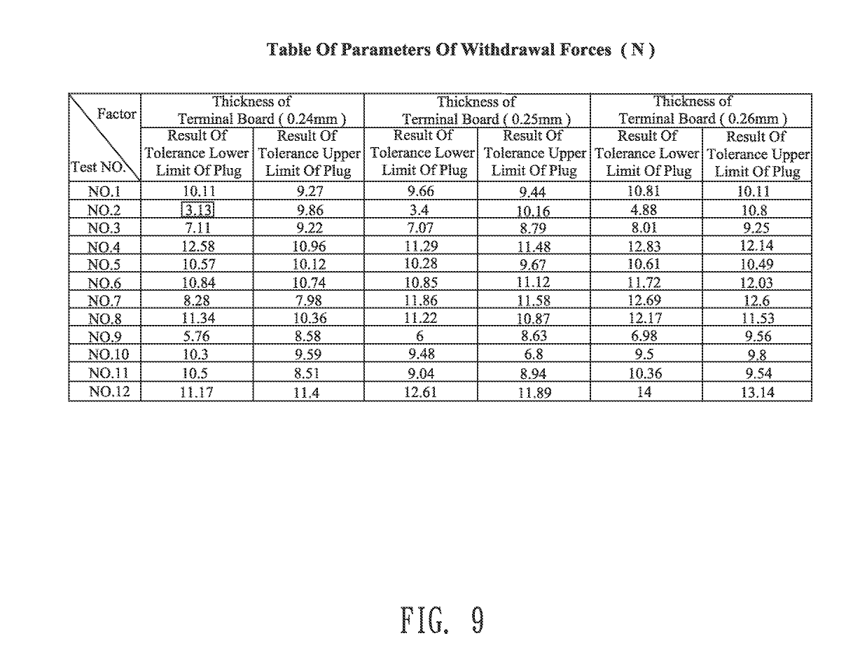

Referring to FIG. 1 to FIG. 9, after the definite element analysis module 211 receives the call of the operating interface 11, reads the multiple groups of test models generated by the model generating module 210 and the definite element analysis parameterization of the digital model 32 to proceed the definite element analysis to get the parameters of insertion and withdrawal forces of the multiple groups of test models after completing the definite element analysis.

After the taguchi calculating module 212 receives the call of the operating interface 11, reads and calculates the quality characteristics of the operating interface 11 and the parameters of the insertion and withdrawal forces generated by the definite element analysis module 211 to get relation variances according to the taguchi analysis formulae.

Referring to FIG. 1 to FIG. 11, after the report module 213 receives the call of the operating interface 11, reads and calculates the relation variances generated by the taguchi calculating module 212 to make the analysis report. The analysis report includes a main effect factor average value chart applied in the taguchi method, and a signal noise proportion chart, analysis data of signal-to-noise ratio variance. The analysis report can be displayed in a user interface or be output into a report document to be provided for the user to use as a basis of optimizing the key dimensions and tolerances of the connector.

The calling method among the operating interface 11, the engineering module 21, the orthogonal table generating module 31 and the digital models 32 belongs to a prior art, and is not limited to the first embodiment herein.

Here lists another calling method among the operating interface 11, the engineering module 21, the orthogonal table generating module 31 and the digital models 32, and according to a second embodiment of the present invention in addition. After the orthogonal table generating module 31 receives and executes the call of the operating interface 11 to generate the test parameters, the orthogonal table generating module 31 calls the model generating module 210 to proceed the calculation. After the model generating module 210 executes to complete the parameters of the insertion and withdrawal forces, the model generating module 210 calls the definite element analysis module 211 to proceed the calculation. After the definite element analysis module 211 executes to complete a parameter analysis of the insertion and withdrawal forces, the definite element analysis module 211 calls the taguchi calculating module 212 to proceed the calculation. After the taguchi calculating module 212 calculates the relation variances, the taguchi calculating module 212 calls the report module 213 to proceed the calculation.

Referring to FIG. 1 to FIG. 5, specifically, the digital model 32 takes an audio connector as the second embodiment of the present invention to be explained:

At first, before the user operates the system for optimizing connector design 100, proceed an analysis of the insertion and withdrawal forces on the digital model 32 through the definite element analysis method in advance, after completing the analysis of the insertion and withdrawal forces, insertion and withdrawal forces of terminals of the audio connector and percentages of the terminals directing at contributions of the overall insertion and withdrawal forces are known, the higher contribution the terminal has, the greater extent the tolerances of the terminals impact on the insertion and withdrawal forces. So, when dimensions of the terminals of the connector are optimized, adjust the terminal having the highest contribution in priority, so the target analysis element according to the second embodiment, chooses a left pin of the digital model 32 as the analysis embodiment.

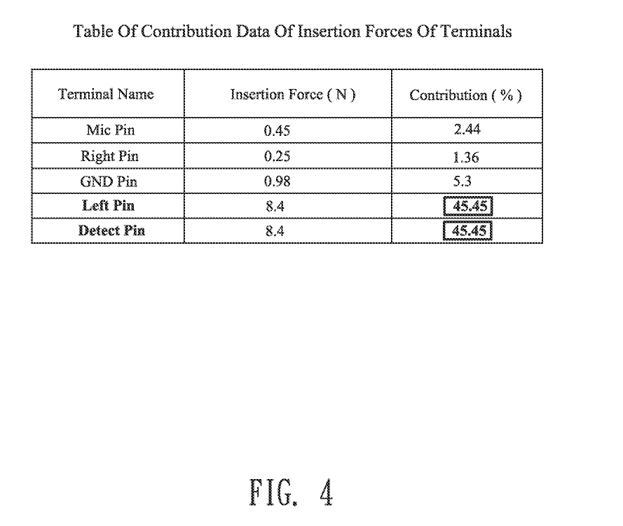

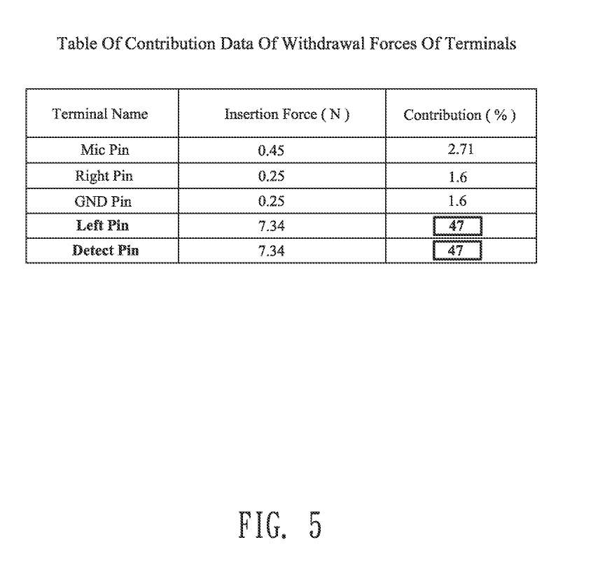

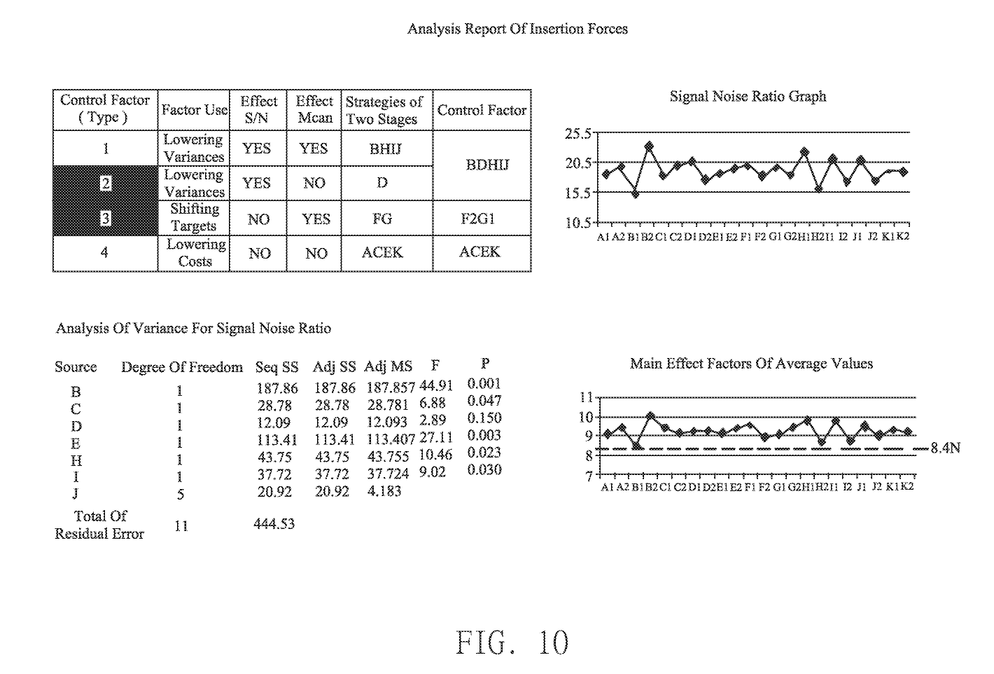

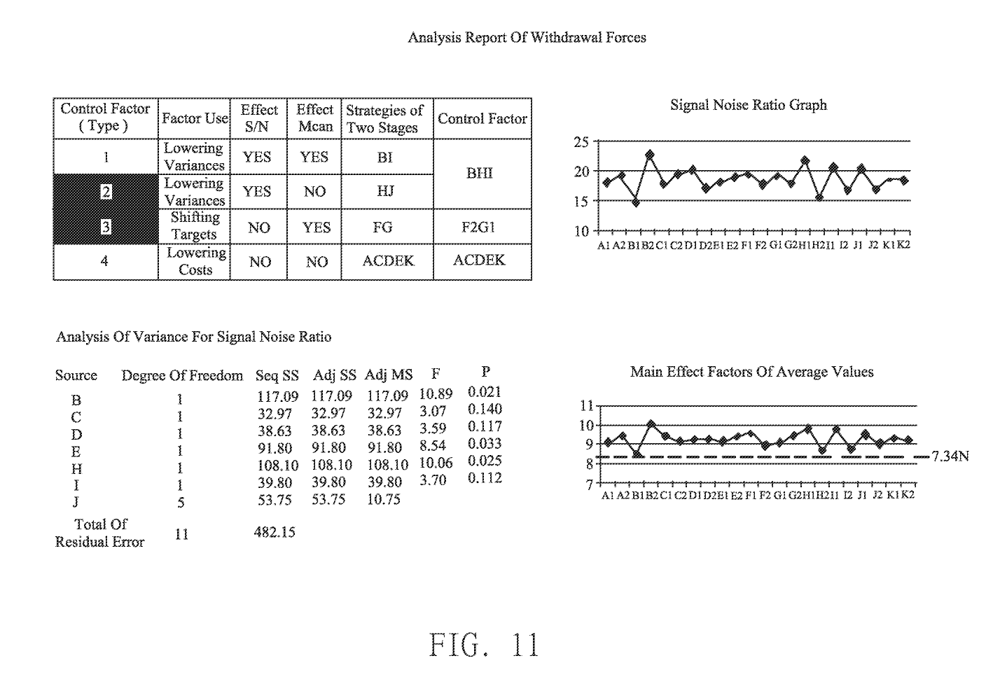

Referring to FIG. 2, FIG. 3, FIG. 4, FIG. 5, FIG. 10 and FIG. 11, after choosing the target analysis element, input the quality characteristics, tolerances of terminal thickness, the key dimensions and tolerances, the orthogonal table format and butting dimension tolerance in the operating interface 11. After completing the input, call the engineering module 21 and the orthogonal table generating module 31 through the operating interface 11 to calculate the analysis report of affecting the insertion and withdrawal forces. In the second embodiment, the quality characteristic is the nominal-the-best characteristic, and the target force value is set as 15.6 N.

Referring to FIG. 2, FIG. 3, FIG. 4 and FIG. 5, in the second embodiment, a choosing way of the key dimensions and tolerances are defined by virtue of a mouse clicking the digital model 32 in the operating interface 11, specifically, in the operating interface 11, area I, area II and area III can be seen, firstly, click the target analysis element option in the area I, select the left pin and an insulating housing in the target analysis element option and set a plan displaying location, after the completion, the plan of the left pin and the insulating housing will be displayed in the area II, the key dimensions and tolerances of the digital model 32 can be defined through a labeling button in the area II, after labeling, the operating interface 11 will read the dimensions information corresponding to the digital model 32, and fill the corresponding dimensions into a blank under the key dimensions in the area III, as “*” mark position is shown in the area III, and label in sequence, in the embodiment, the labels are A˜K in sequence, a tolerance upper limit and a tolerance lower limit in the area III need be filled, and a dimension of the “*” mark position can still receive the modification of the user.

Referring to FIGS. 2-5, FIG. 8 and FIG. 9, the tolerances of terminal thickness and the tolerances of butting dimensions in the area I clicks the noise factor option to label a thickness of the terminal board and label a diameter of the butting connector in the noise factor option, after completing labeling the thickness of the terminal board and labeling the diameter of the butting connector in the noise factor option, the corresponding names and dimensions will be displayed under the control factors and the standards in the area III. In the second embodiment, the labels following K are L˜M in sequence, and then the user fills the tolerance upper limit and the tolerance lower limit again.

The operating interface 11 can store the key dimensions and tolerances data defined by the user to the computer 10 or the database 30, when the user uses the system for optimizing connector design 100 in accordance with the present invention again, if the same element is clicked, the last key dimensions and tolerances can be imported, definition modes of the key dimensions and tolerances, tolerances of terminal thickness, and tolerances of butting dimensions include and are not limited to the second embodiment of the present invention.

The tolerance upper limit and the tolerance lower limit respectively represent the dimension upper limit and the dimension lower limit controlled in a manufacturing process.

The key dimensions and tolerances will affect the insertion and withdrawal forces after the tolerances are changed, after the user defining, as is shown in the area II of the operating interface 11, A is an overall height of the terminal in the deforming direction, B is a distance between a contact point and a bending portion of a front end of the terminal in a vertical direction, C is a distance between the contact point and a tail end of a fastening portion of the terminal in a horizontal direction, D is a fillet diameter of a folding portion of the terminal, E is a length of the fastening portion of the terminal, F is a overall height of the terminal in the vertical deformation direction, G is a width of an elastic portion of the terminal, H is a length of a central line of the insulating housing to an outside of a fastening groove for receiving the terminal, I is a length of the central line of the insulating housing to an outside of an abdicating space, J is a width of the fastening groove of the insulating housing, K is a length of the fastening groove of the insulating housing.

Referring to FIG. 3 to FIG. 7, then, after the user clicks a starting button of the area III, the orthogonal table generating module 31 reads the orthogonal table format, and the key dimensions and tolerances to generate the test parameters.

Referring to FIG. 1 to FIG. 7, the model generating module 210 generates the multiple groups of test models according to the test parameters of the orthogonal table generating module 31 and the tolerances of terminal thickness input by the user, tolerances of butting dimensions and the digital model 32 of the database 30.

Referring to FIG. 2 to FIG. 13, the definite element analysis module 211 analyzes the multiple groups of test models to get the parameters of the insertion and withdrawal forces according to the definite element analysis parameterization.

Referring to FIG. 2 to FIG. 11, after the taguchi calculating module 212 gets the parameters of the insertion and withdrawal forces, calculate the relation variances according to the quality characteristics to let the report module 213 make the analysis report according to the relation variances.

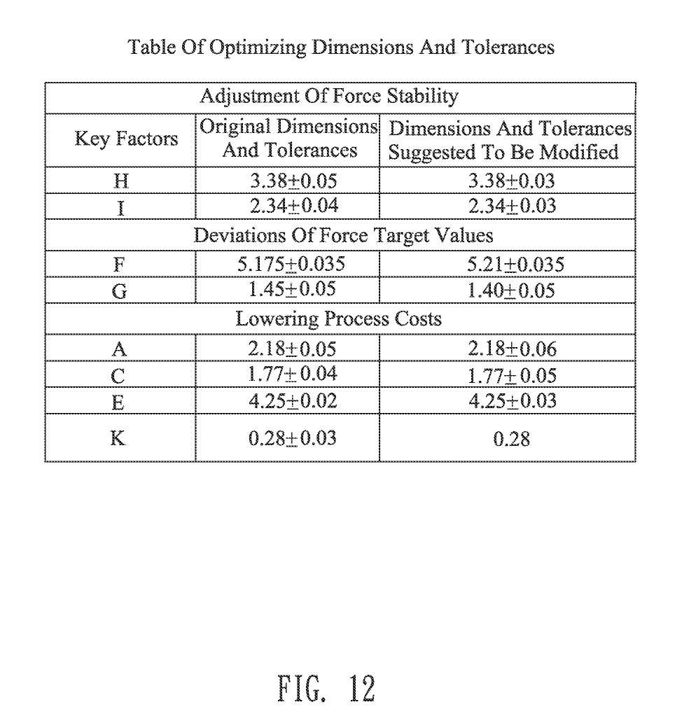

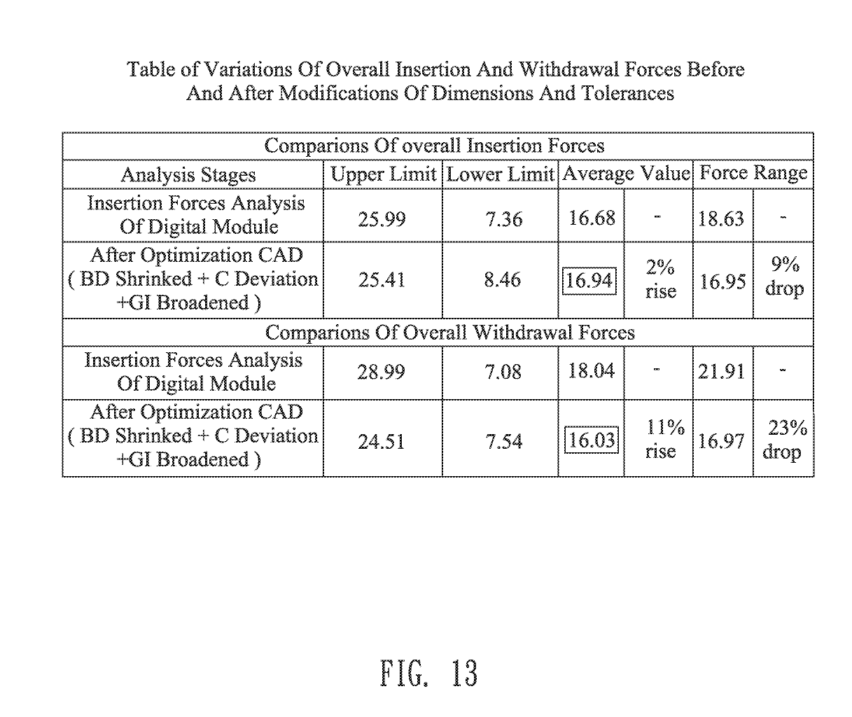

Referring to FIG. 4, FIG. 5, FIG. 12 and FIG. 13, thereby, the user can optimize the key dimensions and tolerances of the digital model 32 according to a content of the analysis report. First of all, adjust directing at a force stability. Specific steps of the adjustment directing at the force stability are described as follows.

At first, in a stage of the adjustment of the force stability, a force shifting is ignored temporarily, choose a proper adjusting factor according to the analysis report, shrink a variation of a force range.

Then, adjust a force target value deviation, and move an average value to close to a target value.

At last, relax tolerances of dimensions of unimportant factors to lower costs, and optimized dimensions of the connector are capable of being got.

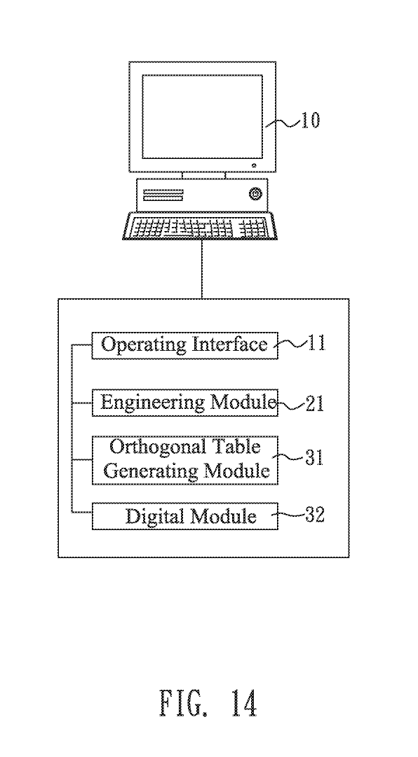

Referring to FIG. 3 and FIG. 14, variances of the overall insertion and withdrawal forces before and after modifications of the dimensions and tolerances are shown in a lower position of FIG. 10, the force range and the average value of the insertion force are obviously close to 15.6 N, the optimized digital models 32 have more stable representations of insertion and withdrawal forces, and reach effects of lowering the force variance range, shifting the force target and lowering the costs.

Referring to FIG. 14, another system for optimizing connector design 100 in accordance with the present invention is shown. The operating interface 11, the engineering module 21, the orthogonal table generating module 31 and the digital model 32 are stored in one of the computers 10, the operating interface 11 calls the engineering module 21 and the orthogonal table generating module 31 to execute the analysis conditions.

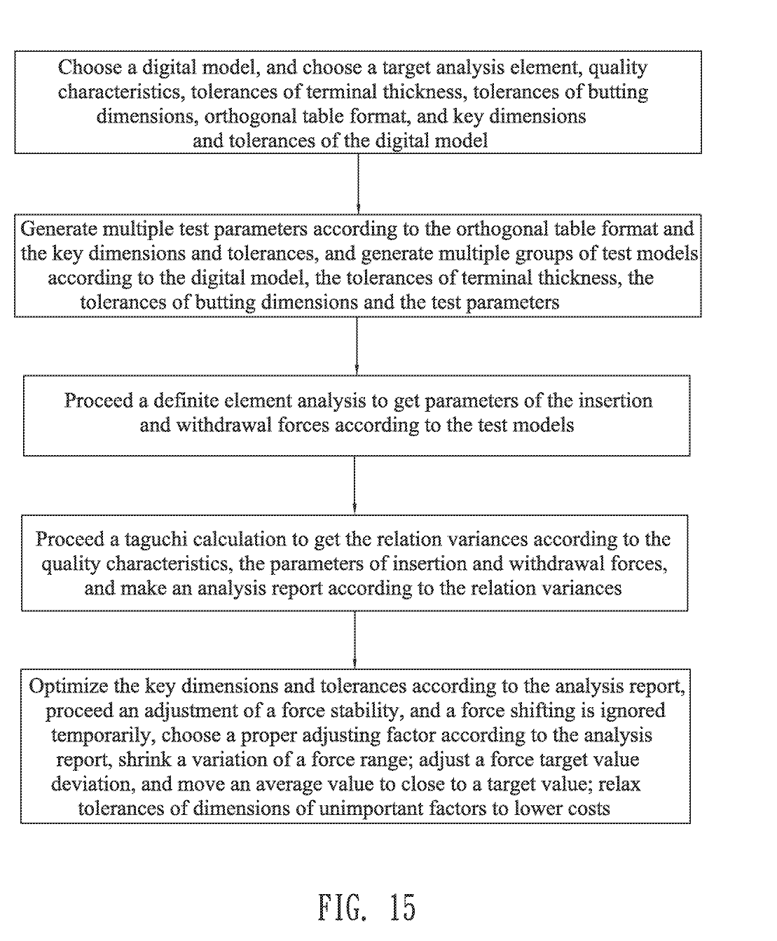

Referring to FIG. 1 to FIG. 15, specific steps of the method for optimizing connector design are described as follows.

Firstly, choose the digital model 32, and choose the target analysis element, the quality characteristics, the tolerances of terminal thickness, the tolerances of butting dimensions, the orthogonal table format, and the key dimensions and tolerances of the digital model 32.

Secondly, generate the multiple test parameters according to the orthogonal table format and the key dimensions and tolerances, and generate the multiple groups of test models according to the digital model 32, the tolerances of terminal thickness, the tolerances of butting dimensions and the test parameters.

Thirdly, proceed the definite element analysis to get the parameters of the insertion and withdrawal forces according to the test models.

Fourthly, proceed a taguchi calculation to get the relation variances according to the quality characteristics, the parameters of insertion and withdrawal forces, and make the analysis report according to the relation variances.

Lastly, the user optimizes the key dimensions and tolerances according to the analysis report, proceed the adjustment of the force stability, and the force shifting is ignored temporarily, choose the proper adjusting factor according to the analysis report, shrink the variation of the force range; adjust the force target value deviation, and move the average value to close to the target value; relax tolerances of dimensions of unimportant factors to lower the costs.

As described above, the system for optimizing connector design 100 automatically outputs the analysis report after the user inputs the analysis conditions by virtue of the method for optimizing connector design to make the analysis data accurate. Thereby, the basis of optimizing the key dimensions and tolerances of the connector are got to reach a purpose of shortening the development time and lowering the costs.

What is claimed is:

1. A system for optimizing connector design, comprising:
at least one digital model;
an operating interface for selecting the digital model and inputting analysis conditions which include target analysis elements, quality characteristics, tolerances of terminal thickness, tolerances of butting dimensions, orthogonal table format, and key dimensions and tolerances of the digital model;
an orthogonal table generating module for reading and calculating the key dimensions and tolerances, and the orthogonal table format to generate multiple groups of test parameters;
a model generating module for reading and calculating test parameters of the orthogonal table generating module and the tolerances of terminal thickness of the operating interface, the tolerances of butting dimensions and the digital model of the database to generate multiple groups of test models;
a definite element analysis module for proceeding a definite element analysis to get the parameters of insertion and withdrawal forces of the multiple groups of test models;
a taguchi calculating module for calculating the quality characteristics and the parameters of the insertion and withdrawal forces to get relation variances; and
a report module for calculating the relation variances generated by the taguchi calculating module to make an analysis report.

2. The system for optimizing connector design as claimed in claim 1, wherein the digital model includes a definite element analysis parameterization which is used for making the definite element analysis module acted as analysis conditions of definite elements.

3. The system for optimizing connector design as claimed in claim 2, wherein the definite element analysis parameterization includes a material property, a network characteristic, a boundary condition and a constraint condition of the digital model.

4. The system for optimizing connector design as claimed in claim 3, further comprising a plurality of computers, a calculation server and a database, the computers interfacing with the calculation server and the database, the calculation server interfacing with the database, the database storing the orthogonal table generating module and the digital model, the computer being equipped with an operating interface, the calculation server being equipped with an engineering module which includes a model generating module, a definite element analysis module, a taguchi calculating module and a report module.

5. The system for optimizing connector design as claimed in claim 4, wherein the digital model is capable of being stored in the database in advance, or input into the database through the operating interface.

6. A method for optimizing connector design, comprising the steps of:
choosing the digital model, and choosing the target analysis element, the quality characteristics, the tolerances of terminal thickness, the tolerances of butting dimensions, the orthogonal table format, and the key dimensions and tolerances of the digital model;
generating multiple test parameters according to the orthogonal table format and the key dimensions and tolerances, and generate the multiple groups of test models according to the digital model, the tolerances of terminal thickness, the tolerances of butting dimensions and the test parameters;
proceeding the definite element analysis to get the parameters of the insertion and withdrawal forces according to the test models; and
proceeding a taguchi calculation to get the relation variances according to the quality characteristics, the parameters of insertion and withdrawal forces, and making the analysis report according to the relation variances.

7. The method for optimizing connector design as claimed in claim 6, wherein the digital model includes a definite element analysis parameterization which is used for making the definite element analysis module acted as analysis conditions of definite elements.

8. The method for optimizing connector design as claimed in claim 7, wherein the definite element analysis parameterization includes a material property, a network characteristic, a boundary condition and a constraint condition of the digital model.

9. The method for optimizing connector design as claimed in claim 8, further comprising the step of optimizing the key dimensions and tolerances according to the analysis report, proceeding the adjustment of a force stability, and a force shifting being ignored temporarily, choosing a proper adjusting factor according to the analysis report, shrinking a variation of a force range, adjusting a force target value deviation, and moving an average value to close to a target value, relaxing tolerances of dimensions of unimportant factors to lower the costs.
